(19) United States
(12) Patent Application Publication
(10) Pub. No.: US 2024/0205890 A1
(43) Pub. Date: Jun. 20, 2024

(54) TSCH ORCHESTRA BASED SCHEDULING APPARATUS AND METHOD USING SUB-GHZ BAND TO INCREASE NETWORK LIFETIME

(71) Applicant: Pusan National University Industry-University Cooperation Foundation, Busan (KR)

(72) Inventors: Sanghwa CHUNG, Busan (KR); Jeongbae PARK, Busan (KR)

(73) Assignee: Pusan National University Industry-University Cooperation Foundation, Busan (KR)

(21) Appl. No.: 18/519,749

(22) Filed: Nov. 27, 2023

(30) Foreign Application Priority Data
Dec. 16, 2022 (KR) 10-2022-0177358

(51) Int. Cl. H04W 72/0446; H04W 72/1263

(52) U.S. Cl. CPC H04W 72/0446; H04W 72/1263

(57) ABSTRACT

A TSCH Orchestra based scheduling apparatus and method using a Sub-Ghz band, includes a preferred parent management module configured to perform storing of preferred parent information by managing preferred parent selection waiting time and managing preferred parent selection operation; a packet transceiver module configured to manage packet reception and packet transmission; and a slot management module configured to manage neighbor transmission slots, and manage reception slots and transmission slots. An operation of applying a sender-based (SB) method to a root device in an Orchestra receiver-based (RB) network is controlled, and a reception slot activation operation using an ACK of the root device, and local duplicate transmission slot avoidance and global duplicate transmission slot avoidance operations are controlled.

### CROSS-REFERENCE TO RELATED APPLICATION

This application claims priority to Korean Patent Application No. 10-2022-0177358 (filed on Dec. 16, 2022), which is hereby incorporated by reference in its entirety.

### BACKGROUND

The present disclosure relates to a TSCH network using a Sub-Ghz band, and more particularly, to a TSCH Orchestra based scheduling apparatus and method using the Sub-Ghz band to increase network lifetime that solves competition issues that arise in a route due to use of the Sub-Ghz band, making it suitable for applications that require provision of low data rates and long-distance communication.

A TSCH network using the Sub-Ghz band has a lower data rate than TSCH using a 2.4 Ghz band, but has a long communication distance, so it is suitable for applications that require low data rates and cover a wide area, such as in the agricultural field.

In particular, in the case of battery-operated IoT devices, wireless communication consumes more battery than the battery used for operations, so the more packet routing is performed, the shorter the lifetime of the IoT device is.

In a tree-type multi-hop network, the closer the IoT device is to the root, the faster its battery consumption increases due to packet routing generated in the subtree.

FIG. 1 is a configuration diagram of a TSCH network using a Sub-Ghz band.

Therefore, when there are no problems in the wireless environment, having as many devices as possible have a root and a single hop helps increase network lifetime.

Orchestra, one of TSCH autonomous scheduling techniques, enables data communication based on a MAC address.

There are two types of scheduling methods for Orchestra's data packet communication: receiver-based (RB) and sender-based (SB) methods.

For the RB method, each IoT device has its own MAC address-based reception slot and consumes less energy by reducing idle listening, but since there is only one slot for reception, multiple devices can compete for packet transmission.

Since the SB method has its own MAC address-based transmission slot, the idle listening time is long to receive packets from other devices, which consumes a lot of energy, but competition is low.

Time slotted channel hopping (TSCH) is described in the following.

According to the IEEE 802.15.4e time slotted channel hopping (TSCH) standard, all devices in the TSCH network are time synchronized with MAC that can avoid external interference through channel hopping and time division communication.

Each device is time synchronized to the network through an enhanced beacon (EB) of devices participating in the network, and reference time information is absolute slot number (ASN).

ASN refers to the number of time slots counted since the start of the network, during which all devices can communicate within the time slots. A slot frame consists of a certain number of time slots, and it has a structure in which slot frames are sequentially repeated.

The formula for the frequency used in each time slot is as follows. Each device pair may communicate through a specific assigned time slot and the frequency corresponding to the time slot, and this process is called link scheduling.

$$CH = macHopSeq [ ( ASN + {CH}_{offset )} \% macHopSeqLen ] \qquad [ Formula 1 ]$$

The Orchestra technique is described in the following.

There are centralized, distributed, and autonomous TSCH link scheduling techniques.

Orchestra is an autonomous scheduling method in which each device generates and maintains its own schedule through rules. In Orchestra, multiple slot frames coexist depending on the type of traffic, and the types of traffic include TSCH beacons, RPL signaling traffic, and application data. The types of time slots include a common shared slot, a receiver-based shared slot (RBS), and a sender-based (shared) slot (SBS), and in the common shared slot, all devices receive or transmit on a competition basis.

In RBS, devices have reception slots based on their device IDs, and child nodes compete for transmission. In SBS, devices have transmission slots based on their device IDs, and parents have reception slots that match transmission slots of their child devices.

IPv6 Routing Protocol Low power and Lossy Networks (RPL) is described in the following.

The Internet Engineering Task Force (IETF) ROLL working group proposed IPv6 Routing Protocol Low power and Lossy Networks (RPL), a standard routing protocol for IPV6-based low-power wireless networks to transfer data between multiple IoT devices.

The protocol forms a tree-based Destination Oriented Directed Acyclic Graph (DODAG), performs routing, and is designed to be suitable for low-power and very noisy network environments such as IEEE 802.15.4 and power line communication. The routing path of the network is established by a set Objective Function (OF), and a separate OF can be used for QoS of each network.

TSCH networks using the Sub-Ghz band have the following problems.

When applying the Sub-Ghz band which is suitable for applications that require the provision of low data rates and long-distance communication, due to increased communication distance, multiple devices can communicate with the root device in a single hop, but when using RB-based scheduling which is suitable for IOT devices that operate on batteries due to their low idle listening time, competition occurs because multiple devices transmit in one reception slot of the root device.

FIG. 2 is a configuration diagram illustrating a competition issue when using RB-based scheduling.

This causes the problem of not being able to select the root device as the parent, and in battery-operated IoT devices, unnecessary multi-hop routing increases battery consumption, shortens network lifetime, and increases end-to-end delay.

Therefore, there is a need for development of new technologies that can solve these problems and improve the limitations of the TSCH autonomous scheduling Orchestra.

### PRIOR-ART DOCUMENTS

### Patent Documents

(Patent Document 1) Korean Patent No. 10-1916328
(Patent Document 2) Korean Patent Application Publication No. 10-2018-0045590
(Patent Document 3) Korean Patent Application Publication No. 10-2022-0064762

### SUMMARY

The present disclosure is intended to solve the problems of the conventional TSCH network using the Sub-Ghz band, and an object is to provide a TSCH Orchestra based scheduling apparatus and method using a Sub-Ghz band to increase network lifetime that solves the competition issues that arise in a route due to the use of the Sub-Ghz band, making it suitable for applications that require the provision of low data rates and long-distance communication.

An object of the present disclosure is to provide a TSCH Orchestra based scheduling apparatus and method using the Sub-Ghz band to increase network lifetime that solves the problem of wireless conflicts occurring using the same slot by, in case of an apparatus that selected the root as their preferred parent, selecting a slot other than the MAC ID of the root to transmit, wherein the transmission from the root device to the child device is transmitted from the MAC ID-based slot of the root device, and all child devices of the root device allocate one additional reception slot for reception.

An object of the present disclosure is to provide a TSCH Orchestra based scheduling apparatus and method using the Sub-Ghz band to increase network lifetime that, by adding a reception slot for the root device, reduces competition between devices which selected the root as the preferred parent and reduces the expected transmission count (ETX), thereby allowing to select the root device as the parent by RPL OF0, and that reduces unnecessary multi-hop routing.

An object of the present disclosure is to provide a TSCH Orchestra based scheduling apparatus and method using the Sub-Ghz band to increase network lifetime for reducing the life imbalance of network devices by applying local duplicate transmission slot avoidance and global duplicate transmission slot avoidance methods, reducing end-to-end delay by reducing unnecessary multi-hop routing and reducing packet collisions by reducing competition near the root device.

Other objects of the present disclosure are not limited to the objects mentioned above, and other objects not mentioned will be clearly understood by those skilled in the art from the descriptions below.

A TSCH Orchestra based scheduling apparatus using a Sub-Ghz band to increase network lifetime according to the present disclosure to achieve the above objects includes a preferred parent management module configured to perform storing of preferred parent information by managing preferred parent selection waiting time and managing preferred parent selection operation; a packet transceiver module configured to manage packet reception and packet transmission; and a slot management module configured to manage neighbor transmission slots, and manage reception slots and transmission slots, wherein the apparatus controls an operation of applying a sender-based (SB) method to a root device in an Orchestra receiver-based (RB) network, and controls a reception slot activation operation using an ACK of the root device, and local duplicate transmission slot avoidance and global duplicate transmission slot avoidance operations.

Here, to apply the SB method to the root device in the Orchestra RB network, in the case of a device which selects a root as a preferred parent, the apparatus may select and transmit a slot other than a MAC ID-based slot of the root in a transmission slot management unit of the slot management module, and transmission from the root device to a child device may be transmitted from the MAC ID-based slot of the root device, and all child devices of the root device may allocate one additional reception slot for reception.

In addition, during the reception slot activation operation using the ACK of the root device, the root device, when it needs to send downstream traffic, may be configured to notify reception slot activation in an ACK packet for packet reception periodically collected from a child device, and the child device which receives a reception slot activation ACK may be configured to necessarily activate a MAC ID-based reception slot of the root device in a next slot frame for reception waiting.

In addition, when applying the SB method to the root device in the Orchestra RB network, the apparatus may control the local duplicate transmission slot avoidance operation to suppress wireless collisions caused by duplicated transmission slot selection between devices.

In addition, to control the local duplicate transmission slot avoidance operation, devices which select the root device as their preferred parent may be configured to transmit their selected transmission slot information in a payload IE to select transmission slots different from each other in the transmission slot management unit of the slot management module.

In addition, a packet reception unit of a packet transceiver module of each of devices which receive transmission slot information may be configured to select a transmission slot excluding slots used by neighbors through a neighbor transmission slot management unit of the slot management module, and perform a change when a neighbor device using the same slot is identified even after selection, and not necessarily select its own MAC ID-based reception slot.

In addition, a waiting time for packet reception of neighbor devices for transmission slot selection in the transmission slot management unit before joining the network may be, when a new root child device is found, reduced in period and initialized by a preferred parent selection waiting time management unit of the preferred parent management module.

In addition, by stopping waiting when the period becomes less than a RPL traffic schedule or an TSCH beacon schedule and determining a transmission slot in the transmission slot management unit, transmission slots to the root between devices within a communication range may be set to avoid duplication.

In addition, during the reception slot activation operation using the ACK of the root device, the apparatus may control the global duplicate transmission slot avoidance operation to prevent duplication of transmission slots with devices outside a communication range.

In addition, for the global duplicate transmission slot avoidance operation, a reception slot management unit of the slot management module of a root may be configured to notify subtree devices with duplicate transmission slots of empty slots and request a change, set transmission slots of devices across the network that select the root device as their preferred parent to avoid duplication, and when there are no empty slots, notify the absence, thereby preventing interference for devices using the same slot.

A TSCH Orchestra based scheduling method using a Sub-Ghz band to increase network lifetime according to the present disclosure to achieve another object, for TSCH Orchestra based scheduling using a Sub-Ghz band in a device including a preferred parent management module configured to perform storing of preferred parent information by managing preferred parent selection waiting time and managing preferred parent selection operation, a packet transceiver module configured to manage packet reception and packet transmission, and a slot management module configured to manage neighbor transmission slots, and manage reception slots and transmission slots, includes controlling an operation of applying a sender-based (SB) method to a root device in an Orchestra receiver-based (RB) network, and controlling a reception slot activation operation using an ACK of the root device, and local duplicate transmission slot avoidance and global duplicate transmission slot avoidance operations.

Here, to apply the SB method to the root device in the Orchestra RB network, in the case of a device which selects a root as a preferred parent, a slot other than a MAC ID-based slot of the root may be selected in a transmission slot management unit of the slot management module to transmitted, and transmission from the root device to a child device may be transmitted from the MAC ID-based slot of the root device, and all child devices of the root device may allocate one additional reception slot for reception.

In addition, during the reception slot activation operation using the ACK of the root device, the root device, when it needs to send downstream traffic, may notify reception slot activation in an ACK packet for packet reception periodically collected from a child device, and the child device which receives a reception slot activation ACK may necessarily activate a MAC ID-based reception slot of the root device in a next slot frame for reception waiting.

In addition, when applying the SB method to the root device in the Orchestra RB network, the local duplicate transmission slot avoidance operation may be controlled to suppress wireless collisions caused by duplicated transmission slot selection between devices.

In addition, to control the local duplicate transmission slot avoidance operation, the method may include receiving an EB to store transmission slot information, if any, and determining whether TSCH is synchronized, if TSCH is synchronized, determining whether there is a preferred parent and, if so, determining whether a packet is from a device whose preferred parent is the root, if the packet is from a device whose preferred parent is the root, determining whether the preferred parent is the root, and if the preferred parent is the root, determining whether a transmission slot is duplicated, and if the transmission slot is duplicated, determining whether a transmission slot changing is possible, and if changing is possible, setting the transmission slot and completing packet reception.

In addition, if the transmission slot is duplicated, it is determined whether the transmission slot changing is possible, and if the transmission slot changing is not possible, a preferred parent excluding the root may be reselected and packet reception may be completed, and it is determined whether TSCH is synchronized, and if TSCH is not synchronized, TSCH synchronization may be performed and packet reception may be completed.

In addition, to control the local duplicate transmission slot avoidance operation, the method may include receiving DIO to store transmission slot information if any, and storing rank, determining whether there is a preferred parent and, if there is a preferred parent, determining whether the preferred parent is the root, if the preferred parent is the root, determining whether a packet is from a device whose preferred parent is the root, if the packet is from a device whose preferred parent is the root, determining whether a transmission slot is duplicated, and when duplicated, determining whether a transmission slot changing is possible, and if the transmission slot changing is possible, setting the transmission slot and completing packet reception, and if the transmission slot changing is not possible, reselecting a preferred parent excluding the root and completing packet reception.

In addition, it is determined whether there is a preferred parent, and if there is no preferred parent, ranks of neighbors may be compared and the preferred parent may be determined, and it is determined whether the determined preferred parent is the root, and if the preferred parent is the root, waiting for transmission slot setting may begin and packet reception may be completed.

In addition, to control the local duplicate transmission slot avoidance operation, the method may include, when a packet is received, determining whether there is a waiting time remaining, and if there is a waiting time remaining, determining whether the packet is from a device whose preferred parent is the root, if the packet is from a device whose preferred parent is the root, determining whether it is new transmission slot information, if it is new transmission slot information, storing the transmission slot information, reducing the waiting time, and initializing, determining whether the waiting time is greater than a minimum waiting time, and if the waiting time is greater than the minimum waiting time, completing packet reception.

In addition, it is determined whether there is a waiting time remaining, and if there is no waiting time remaining, or it is determined whether the waiting time is greater than the minimum waiting time, and if the waiting time is not greater than the minimum waiting time, it may be determined whether a transmission slot setting is possible, and if the transmission slot setting is not possible, the preferred parent excluding the root may be reselected, and if the transmission slot setting is possible, a transmission slot may be set and packet reception may be completed.

In addition, the global duplicate transmission slot avoidance operation may be controlled to prevent duplication of transmission slots with devices outside a communication range.

In addition, to control the global duplicate transmission slot avoidance operation, the method may include, when a packet is received, determining whether there are two or more devices using the same slot, if there are two or more devices using the same slot, determining whether there are unused reception slots, if there are unused reception slots, transmitting a list of unused reception slots and completing packet reception, and if there are no unused reception slots, requesting a parent change and completing packet reception.

A TSCH Orchestra based scheduling apparatus and method using a Sub-Ghz band to increase network lifetime according to the present disclosure as described above have the following effects.

First, by solving the competition problems that arise in the route due to the use of the Sub-Ghz band, it is suitable for applications that require the provision of low data rates and long-distance communication, and can increase network lifetime.

Second, in case of a device which selects the root as a preferred parent, it selects a slot other than the MAC ID-based slot of the root to transmit, and transmission from the root device to the child device is transmitted from the MAC ID-based slot of the root, and all child devices of the root device allocate one additional reception slot for reception to solve the problem of wireless collisions occurring by using the same slot.

Third, by adding a reception slot for the root device, competition between devices that have selected root as their preferred parent is reduced, and by reducing the expected transmission count (ETX), the root device can be selected as the parent by RPL OF0 and unnecessary multi-hop routing can be reduced.

Fourth, by applying local duplicate transmission slot avoidance and global duplicate transmission slot avoidance methods, life imbalance of network devices can be reduced, end-to-end delay can be reduced by reducing unnecessary multi-hop routing, and packet collisions can be reduced by reducing competition near the root device.

### BRIEF DESCRIPTION OF THE DRAWINGS

FIG. 1 is a configuration diagram of a TSCH network using a Sub-Ghz band.

FIG. 2 is a configuration diagram illustrating a competition issue when using RB-based scheduling.

FIG. 3 is a configuration diagram illustrating a wireless collision occurring using the same slot.

FIG. 4 is a configuration diagram illustrating child devices allocating one additional reception slot for reception.

FIG. 5 is a configuration diagram of a TSCH Orchestra-based scheduling device using a Sub-Ghz band to increase network lifetime according to the present disclosure.

FIG. 6 is a flow chart illustrating a local duplicate transmission slot avoidance method during EB reception.

FIG. 7 is a flow chart illustrating a local duplicate transmission slot avoidance method during DIO reception.

FIG. 8 is a flow chart illustrating a local duplicate transmission slot avoidance method during packet reception.

FIG. 9 is a configuration diagram illustrating an issue of transmission slot duplication with devices outside a communication range.

FIG. 10 is a flow chart illustrating a global duplicate transmission slot avoidance method.

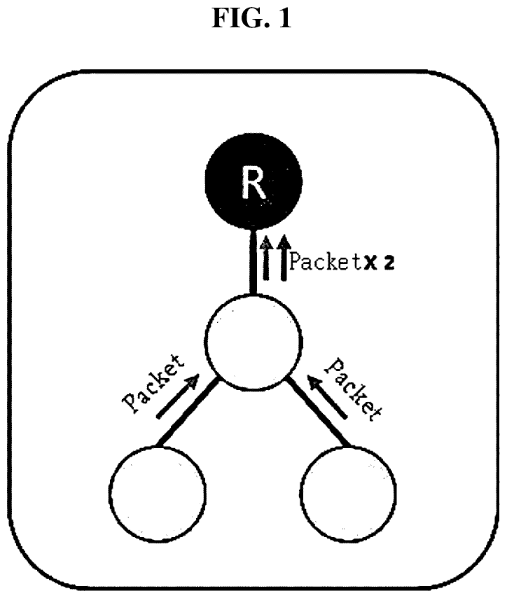

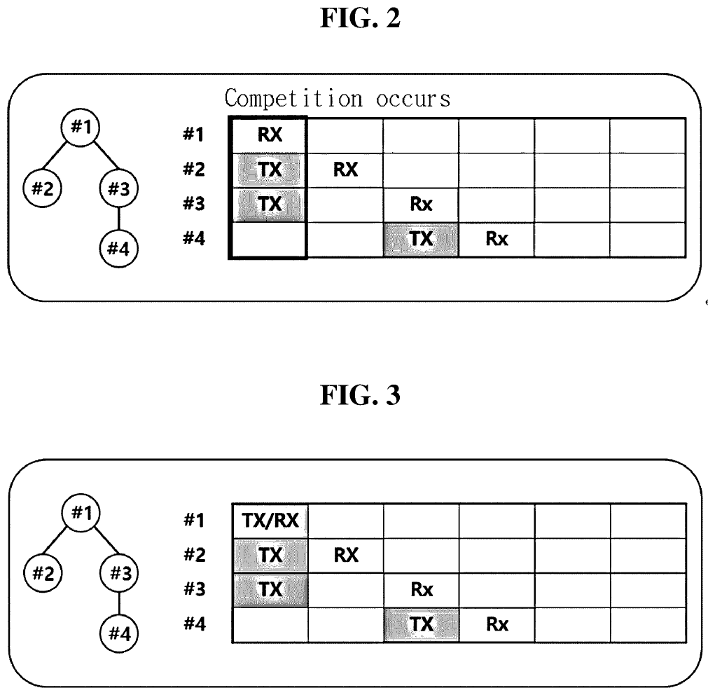

### DETAILED DESCRIPTION

Hereinafter, preferred embodiments of a TSCH Orchestra based scheduling apparatus and method using a Sub-Ghz band to increase network lifetime according to the present disclosure will be described in detail as follows.

Features and advantages of the TSCH Orchestra based scheduling apparatus and method using the Sub-Ghz band to increase network lifetime according to the present disclosure will become apparent through the detailed description of each embodiment below.

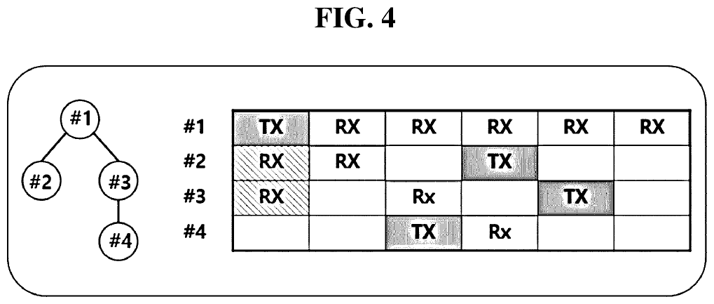

FIG. 3 is a configuration diagram illustrating a wireless collision occurring using the same slot, and FIG. 4 is a configuration diagram illustrating child devices allocating one additional reception slot for reception.

As terms used in the present disclosure, general terms that are currently widely used as much as possible have been selected while considering the functions in the present disclosure, but they may vary depending on the intention or precedents of those skilled in the art, the emergence of new technologies, and the like. In addition, in certain cases, there are terms arbitrarily selected by the applicant, and in this case, their meanings will be described in detail in the relevant detailed description. Therefore, the term used in the present disclosure should be defined based on the meaning of the term and the overall content of the present disclosure, rather than simply the name of the term.

When it is said that a part “includes” a component throughout the specification, this means that, unless specifically stated to the contrary, it does not exclude other components but may further include other components. In addition, the terms such as “ . . . unit” and “module” used in the specification refer to a unit that processes at least one function or operation, which may be implemented as hardware or software, or as a combination of hardware and software.

In particular, units that process at least one function or operation may be implemented as an electronic device including at least one processor, and at least one peripheral device may be connected to the electronic device depending on the method of processing the function or operation. Peripheral devices may include data input devices, data output devices, and data storage devices.

The TSCH Orchestra based scheduling apparatus and method using the Sub-Ghz band to increase network lifetime according to the present disclosure are suitable for applications that require the provision of low data rates and long-distance communication by solving competition issues that occur in the route due to the use of the Sub-Ghz band.

To this end, the present disclosure may include a configuration in which, in case of a device which selects the root as a preferred parent, a slot other than the MAC ID-based slot of the root is selected to transmit, and transmission from the root device to the child device is transmitted from the MAC ID-based slot of the root, and all child devices of the root device allocate one additional reception slot for reception to solve the problem of wireless collisions occurring by using the same slot.

The present disclosure may include a configuration in which, by adding a reception slot for the root device, competition between devices that have selected root as their preferred parent is reduced, and by reducing the expected transmission count (ETX), the root device can be selected as the parent by RPL OF0 and unnecessary multi-hop routing can be reduced.

The present disclosure may, by applying local duplicate transmission slot avoidance and global duplicate transmission slot avoidance methods, reduce life imbalance of network devices, reduce end-to-end delay by reducing unnecessary multi-hop routing, and reduce packet collisions by reducing competition near the root device.

First, [Application of SB method to root device in Orchestra RB method network] is described as follows.

The Orchestra SB method cannot be adopted in battery-operated devices due to power consumption due to long idle listening time. However, in most wireless sensor network applications, the root device is connected to an external network and receives power, so the SB method can be selected in the root device.

However, it is impossible to operate both the SB method and the RB method in the same network.

For example, if the SB method is selected on the root device, transmission from the root device to the child device is impossible, and the root device transmits from its own MAC ID-based slot, but likewise, when a child device operating in the RB method transmits to the root device, it transmits from the MAC ID-based slot of the root device, so a wireless collision occurs using the same slot as shown in FIG. 3.

Therefore, in case of a device that selects the root as the preferred parent, the transmission slot management unit selects a slot other than the MAC ID-based slot of the root for transmission. Transmission from the root device to the child device is transmitted from the MAC ID-based slot of the root device, and as shown in FIG. 4, all child devices of the root device allocate one additional reception slot for reception.

When applying this method, since there are multiple reception slots of the root device, competition between devices that select the root as the preferred parent is reduced compared to a network formed only by the RB method, and the expected transmission count (ETX) is reduced. ETX reduction may cause the root device to be selected as the parent by RPL OF0 and reduce unnecessary multi-hop routing.

In addition, [Reception slot activation using the ACK of the root device] is described as follows.

For applications for data collection in most wireless sensor networks, upstream traffic from the end device to the root device accounts for most of the traffic, and downward traffic from the root device to the end device occurs in special control packets such as RPL's DAO ACK.

Since it is inefficient in terms of energy consumption for the idle listening time of all child devices of all root devices to increase for downward traffic, when the root device needs to send downstream traffic, it notifies the activation of the reception slot in the ACK packet for packet reception periodically collected from the child devices.

The child device that receives the reception slot activation ACK must activate the MAC ID-based reception slot of the root device and wait for reception in the next slot frame.

In addition, [Local duplicate transmission slot avoidance] is described as follows.

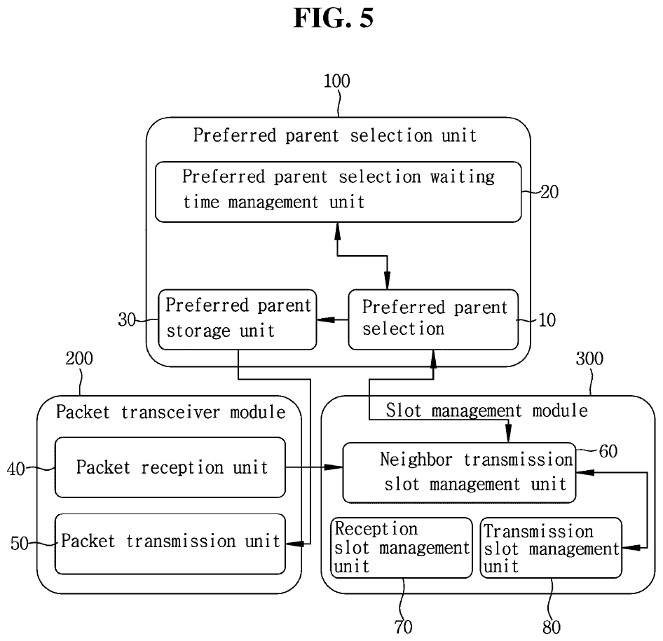

FIG. 5 is a configuration diagram of a TSCH Orchestra-based scheduling device using a Sub-Ghz band to increase network lifetime according to the present disclosure.

As shown in FIG. 5, a TSCH Orchestra-based scheduling device using a Sub-Ghz band to increase network lifetime according to the present disclosure includes a preferred parent management module 100, a packet transceiver module 200, and a slot management module 300.

The preferred parent management module 100 includes a preferred parent selection unit 10, a preferred parent selection waiting time management unit 20, and a preferred parent storage unit 30.

The packet transceiver module 200 includes a packet reception unit 40 and a packet transmission unit 50.

The slot management module 300 includes a neighbor transmission slot management unit 60, a reception slot management unit 70, and a transmission slot management unit 80.

When [applying the sender-based (SB) method to the root device in an Orchestra receiver-based (RB) network], devices that select the root device as their preferred parent must autonomously determine transmission slots, but wireless collisions may occur when duplicated transmission slots are selected between devices.

For example, if all devices select the same transmission slot, the root device is the same as the network that selected the RB method.

Therefore, devices that select the root device as their preferred parent transmit their selected transmission slot information in the payload IE in order to select different transmission slots in the transmission slot management unit 80.

The packet reception units 40 of the devices that have received this select transmission slots excluding the slots used by the neighbors through the neighbor transmission slot management unit 60, and change when they identify neighboring devices using the same slot even after selection.

At this time, its own MAC ID-based reception slot is not necessarily selected.

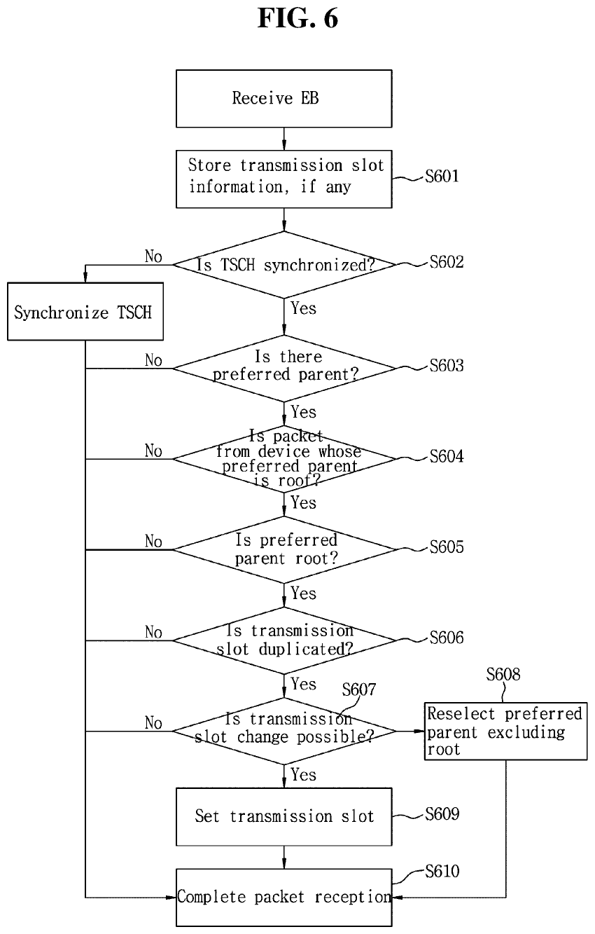

FIG. 6 is a flow chart illustrating a local duplicate transmission slot avoidance method during EB reception.

First, an EB is received, and if there is transmission slot information, it is stored (S601), and it is determined whether TSCH is synchronized (S602).

If TSCH is synchronized, it is determined whether there is a preferred parent (S603), and, if so, it is determined whether the packet is from a device whose preferred parent is the root (S604).

If the preferred parent is a packet of the root device, it is determined whether the preferred parent is the root (S605), and if the preferred parent is the root, it is determined whether the transmission slot is duplicated (S606).

If the transmission slot is duplicated, it is determined whether a transmission slot changing is possible (S607), and if changing is possible, transmission slot setting is performed (S608) and packet reception is completed (S610).

If the transmission slot changing is not possible, a preferred parent is re-selected excluding the root (S608), and packet reception is completed (S610).

Here, it is determined whether TSCH is synchronized (S602), and if TSCH is not synchronized, TSCH is synchronized and packet reception is completed (S610).

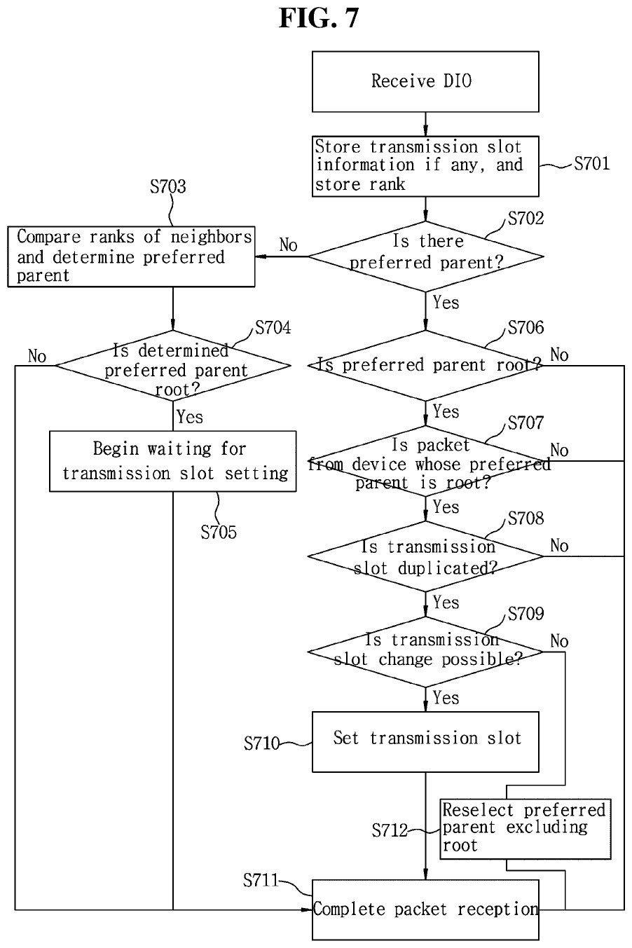

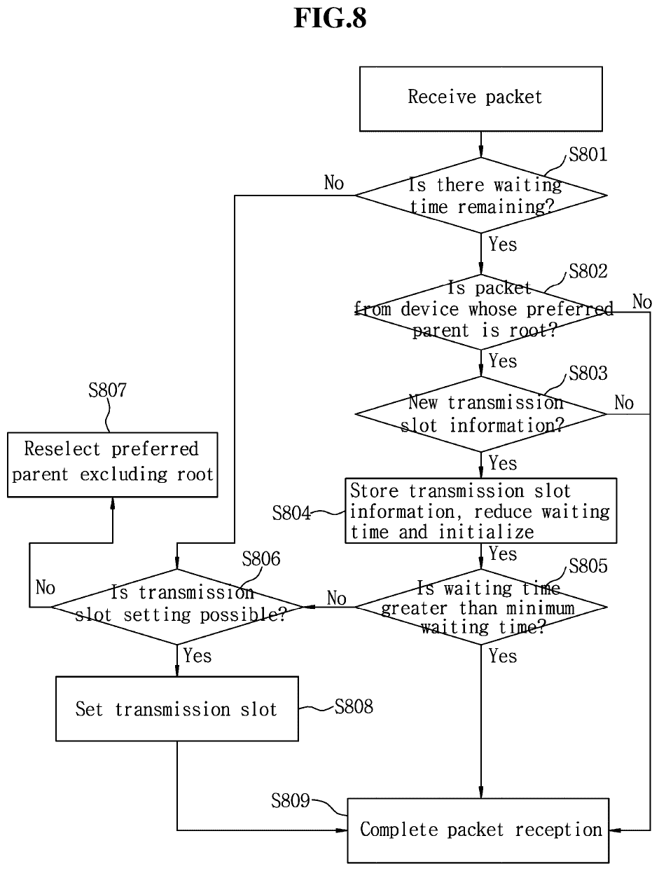

FIG. 7 is a flow chart illustrating a local duplicate transmission slot avoidance method during DIO reception.

First, DIO is received, and if there is transmission slot information, it is stored and rank is stored (S701).

Then, it is determined whether there is a preferred parent (S706), and if there is a preferred parent, it is determined whether the preferred parent is the root (S706).

If the preferred parent is the root, it is determined whether the packet is from a device whose preferred parent is the root (S707).

In addition, if the packet is from a device whose preferred parent is the root, it is determined whether the transmission slot is duplicated (S708), and when duplicated, it is determined whether a transmission slot changing is possible (S709).

If the transmission slot changing is possible, transmission slot setting is performed (S710) and packet reception is completed (S711), and if the transmission slot changing is not possible, a preferred parent is reselected excluding the root (S712) and packet reception is completed (S711).

Here, it is determined whether there is a preferred parent (S706), and if there is no preferred parent, the ranks of neighbors are compared and the preferred parent is determined (S703), and it is determined whether the determined preferred parent is the root (S704), and if the preferred parent is the root, waiting for transmission slot setting starts (S705) and packet reception is completed (S711).

In addition, packet reception waiting time of neighboring devices for transmission slot selection in the transmission slot management unit 80 before joining the network is, when a new root child device is found, reduced in period and reset by a preferred parent selection waiting time management unit 20 of the preferred parent management module.

When the period becomes smaller than the RPL traffic schedule or TSCH beacon schedule, waiting is stopped and the transmission slot management unit 80 determines the transmission slot.

When applying this technique, it is possible to set transmission slots to the route between devices within the communication range of the device so as to avoid duplication.

The process of determining a transmission slot in the transmission slot management unit 80 is described as follows.

FIG. 8 is a flow chart illustrating a local duplicate transmission slot avoidance method during packet reception.

First, when a packet is received, it is determined whether there is a waiting time remaining (S801), and if there is a waiting time remaining, it is determined whether the packet is from a device whose preferred parent is the root (S802).

If the packet is from a device whose preferred parent is the root, it is determined whether it is new transmission slot information (S803).

Then, if it is new transmission slot information, the transmission slot information is stored, the waiting time is reduced and initialized (S804).

In addition, it is determined whether the waiting time is greater than a minimum waiting time (S805), and if the waiting time is greater than the minimum waiting time, packet reception is completed (S809).

Here, it is determined whether there is a waiting time remaining (S801), and if there is no waiting time remaining, or it is determined whether the waiting time is greater than the minimum waiting time (S805), and if the waiting time is not greater than the minimum waiting time, it is determined whether a transmission slot setting is possible (S806).

If the transmission slot setting is not possible, the preferred parent is reselected excluding the root (S807), and if the transmission slot setting is possible, the transmission slot setting is performed (S808) and packet reception is completed (S809).

[Global duplicate transmission slot avoidance] is described as follows.

When applying the [Reception slot activation using the ACK of the root device] method, in the transmission slot management unit 80 of a device that selects the root device as the preferred parent, it is possible to set so that transmission slots to the root between devices within the communication range are not duplicated, but the transmission slot may be duplicatid with devices outside the communication range.

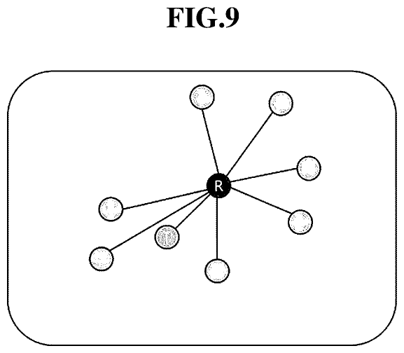

FIG. 9 is a configuration diagram illustrating an issue of transmission slot duplication with devices outside a communication range.

The reception slot management unit 70 of the root notifies subtree devices with duplicated transmission slots of empty slots and requests a change.

When applying this technique, the transmission slots of devices throughout the network that select the root device as the preferred parent may be set to avoid duplication.

If there are no empty slots, it is notified that there are none, so as not to affect devices that are already using the same slot.

This process is described in detail as follows.

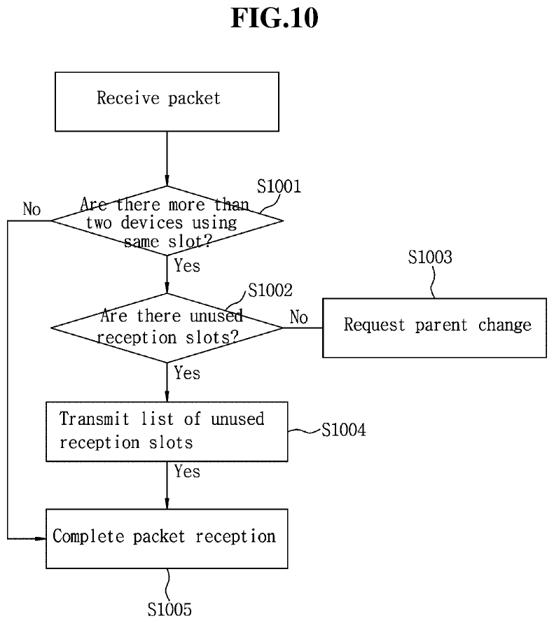

FIG. 10 is a flow chart illustrating a global duplicate transmission slot avoidance method.

First, when a packet is received, it is determined whether there are two or more devices using the same slot (S1001).

Then, if there are two or more devices using the same slot, it is determined whether there are unused reception slots (S1002).

If there are unused reception slots, a list of unused reception slots is transmitted (S1004) and packet reception is completed (S1005).

If there are no unused reception slots, a parent change is requested (S1003) and packet reception is completed (S1005).

The TSCH Orchestra based scheduling apparatus and method using the Sub-Ghz band to increase network lifetime according to the present disclosure described above is suitable for applications that require the provision of low data rates and long-distance communication by solving competition issues that occur in the route due to the use of the Sub-Ghz band.

As described above, it will be understood that the present disclosure is implemented in a modified form without departing from the essential characteristics of the present disclosure.

Therefore, the specified embodiments should be considered from an illustrative rather than a restrictive perspective, and the scope of the present disclosure is indicated in the claims rather than the foregoing description, and all differences within the equivalent scope should be construed as being included in the present disclosure.

### EXPLANATION OF SYMBOLS

100. Preferred parent management module
200. Packet transceiver module
300. Slot management module

What is claimed is:

1. A TSCH Orchestra based scheduling apparatus using a Sub-Ghz band to increase network lifetime, the apparatus comprising:
a preferred parent management module configured to perform storing of preferred parent information by managing preferred parent selection waiting time and managing preferred parent selection operation;
a packet transceiver module configured to manage packet reception and packet transmission; and
a slot management module configured to manage neighbor transmission slots, and manage reception slots and transmission slots,
wherein the apparatus controls an operation of applying a sender-based (SB) method to a root device in an Orchestra receiver-based (RB) network, and
controls a reception slot activation operation using an ACK of the root device, and local duplicate transmission slot avoidance and global duplicate transmission slot avoidance operations.

2. The apparatus of claim 1, wherein, to apply the SB method to the root device in the Orchestra RB network,
in the case of a device which selects a root as a preferred parent, the apparatus selects and transmits a slot other than a MAC ID-based slot of the root in a transmission slot management unit of the slot management module, and
transmission from the root device to a child device is transmitted from the MAC ID-based slot of the root device, and all child devices of the root device allocate one additional reception slot for reception.

3. The apparatus of claim 1, wherein, during the reception slot activation operation using the ACK of the root device,
the root device, when it needs to send downstream traffic, is configured to notify reception slot activation in an ACK packet for packet reception periodically collected from a child device, and
the child device which receives a reception slot activation ACK is configured to necessarily activate a MAC ID-based reception slot of the root device in a next slot frame for reception waiting.

4. The apparatus of claim 1, wherein, when applying the SB method to the root device in the Orchestra RB network,
the apparatus controls the local duplicate transmission slot avoidance operation to suppress wireless collisions caused by duplicated transmission slot selection between devices.

5. The apparatus of claim 4, wherein, to control the local duplicate transmission slot avoidance operation,
devices which select the root device as their preferred parent are configured to transmit their selected transmission slot information in a payload IE to select transmission slots different from each other in the transmission slot management unit of the slot management module.

6. The apparatus of claim 5, wherein a packet reception unit of a packet transceiver module of each of devices which receive transmission slot information is configured to:
select a transmission slot excluding slots used by neighbors through a neighbor transmission slot management unit of the slot management module; and
perform a change when a neighbor device using the same slot is identified even after selection, and not necessarily select its own MAC ID-based reception slot.

7. The apparatus of claim 5, wherein a waiting time for packet reception of neighbor devices for transmission slot selection in the transmission slot management unit before joining the network is, when a new root child device is found,
reduced in period and initialized by a preferred parent selection waiting time management unit of the preferred parent management module.

8. The apparatus of claim 7, wherein, by stopping waiting when the period becomes less than a RPL traffic schedule or an TSCH beacon schedule and determining a transmission slot in the transmission slot management unit,
transmission slots to the root between devices within a communication range are set to avoid duplication.

9. The apparatus of claim 1, wherein the apparatus controls the global duplicate transmission slot avoidance operation to prevent duplication of transmission slots with devices outside a communication range.

10. The apparatus of claim 9, wherein, for the global duplicate transmission slot avoidance operation,
a reception slot management unit of a slot management module of a root is configured to notify subtree devices with duplicate transmission slots of empty slots and request a change,
set transmission slots of devices across the network that select the root device as their preferred parent to avoid duplication, and
when there are no empty slots, notify the absence, thereby preventing interference for devices using the same slot.

11. A TSCH Orchestra based scheduling method using a Sub-Ghz band to increase network lifetime, wherein for TSCH Orchestra based scheduling using a Sub-Ghz band in an apparatus comprising a preferred parent management module configured to perform storing of preferred parent information by managing preferred parent selection waiting time and managing preferred parent selection operation, a packet transceiver module configured to manage packet reception and packet transmission, and a slot management module configured to manage neighbor transmission slots, and manage reception slots and transmission slots,
the method comprises controlling an operation of applying a sender-based (SB) method to a root device in an Orchestra receiver-based (RB) network, and
controlling a reception slot activation operation using an ACK of the root device, and local duplicate transmission slot avoidance and global duplicate transmission slot avoidance operations.

12. The method of claim 11, wherein, to apply the SB method to the root device in the Orchestra RB network,
in the case of a device which selects a root as a preferred parent, a slot other than a MAC ID-based slot of the root is selected in a transmission slot management unit of the slot management module and transmitted, and
transmission from the root device to a child device is transmitted from the MAC ID-based slot of the root device, and all child devices of the root device allocate one additional reception slot for reception.

13. The method of claim 11, wherein, during the reception slot activation operation using the ACK of the root device,
the root device, when it needs to send downstream traffic, notifies reception slot activation in an ACK packet for packet reception periodically collected from a child device, and
the child device which receives a reception slot activation ACK necessarily activates a MAC ID-based reception slot of the root device in a next slot frame for reception waiting.

14. The method of claim 11, wherein, when applying the SB method to the root device in the Orchestra RB network,
the local duplicate transmission slot avoidance operation is controlled to suppress wireless collisions caused by duplicated transmission slot selection between devices.

15. The method of claim 14, wherein, to control the local duplicate transmission slot avoidance operation, the method comprises:
receiving an EB to store transmission slot information, if any, and determining whether TSCH is synchronized,
if TSCH is synchronized, determining whether there is a preferred parent and, if so, determining whether a packet is from a device whose preferred parent is the root,
if the packet is from a device whose preferred parent is the root, determining whether the preferred parent is the root, and if the preferred parent is the root, determining whether a transmission slot is duplicated, and
if the transmission slot is duplicated, determining whether transmission slot changing is possible, and if changing is possible, setting the transmission slot and completing packet reception.

16. The method of claim 15, wherein, if the transmission slot is duplicated, it is determined whether the transmission slot changing is possible, and if the transmission slot changing is not possible,
a preferred parent excluding the root is reselected and packet reception is completed, and
it is determined whether TSCH is synchronized, and if TSCH is not synchronized, TSCH synchronization is performed and packet reception is completed.

17. The method of claim 14, wherein, to control the local duplicate transmission slot avoidance operation, the method comprises:
receiving DIO to store transmission slot information if any, and storing ranks;
determining whether there is a preferred parent and, if there is a preferred parent, determining whether the preferred parent is the root,
if the preferred parent is the root, determining whether a packet is from a device whose preferred parent is the root,
if the packet is from a device whose preferred parent is the root, determining whether a transmission slot is duplicated, and when duplicated, determining whether a transmission slot changing is possible, and
if the transmission slot changing is possible, setting the transmission slot and completing packet reception, and if the transmission slot changing is not possible, reselecting a preferred parent excluding the root and completing packet reception.

18. The method of claim 17, wherein, it is determined whether there is a preferred parent, and if there is no preferred parent, ranks of neighbors are compared and the preferred parent is determined, and
it is determined whether the determined preferred parent is the root, and if the preferred parent is the root, waiting for transmission slot setting begins and packet reception is completed.

19. The method of claim 14, wherein, to control the local duplicate transmission slot avoidance operation, the method comprises:
when a packet is received, determining whether there is a waiting time remaining, and if there is a waiting time remaining, determining whether the packet is from a device whose preferred parent is the root,
if the packet is from a device whose preferred parent is the root, determining whether it is new transmission slot information,
if it is new transmission slot information, storing the transmission slot information, reducing the waiting time, and initializing, and
determining whether the waiting time is greater than a minimum waiting time, and if the waiting time is greater than the minimum waiting time, completing packet reception.

20. The method of claim 19, wherein, it is determined whether there is a waiting time remaining, and if there is no waiting time remaining, or it is determined whether the waiting time is greater than the minimum waiting time, and if the waiting time is not greater than the minimum waiting time, it is determined whether a transmission slot setting is possible, and
if the transmission slot setting is not possible, the preferred parent excluding the root is reselected, and if the transmission slot setting is possible, a transmission slot is set and packet reception is completed.

21. The method of claim 11, wherein, during the reception slot activation operation using the ACK of the root device,
the global duplicate transmission slot avoidance operation is controlled to prevent duplication of transmission slots with devices outside a communication range.

22. The method of claim 21, wherein, to control the global duplicate transmission slot avoidance operation, the method comprises:
when a packet is received, determining whether there are two or more devices using the same slot,
if there are two or more devices using the same slot, determining whether there are unused reception slots,
if there are unused reception slots, transmitting a list of unused reception slots and completing packet reception, and
if there are no unused reception slots, requesting a parent change and completing packet reception.
